(19) United States
(12) Patent Application Publication
(10) Pub. No.: US 2013/0159869 A1
(43) Pub. Date: Jun. 20, 2013

(54) SYSTEM AND METHOD FOR BROADCASTING MASS MARKET MESSAGES OVER A NETWORK OF SCREENS

(71) Applicant: Crowdscreens, LLC, New York, NY (US)

(72) Inventor: Ali FARAJI, Englewood Cliffs, NJ (US)

(73) Assignee: Crowdscreens, LLC, New York, NY (US)

(21) Appl. No.: 13/722,882

(22) Filed: Dec. 20, 2012

Related U.S. Application Data
(60) Provisional application No. 61/578,051, filed on Dec. 20, 2011.

(51) Int. Cl. G06F 3/0482

(52) U.S. Cl. CPC G06F 3/0482
USPC 715/738

(57) ABSTRACT

A system and method for broadcasting media comprising a server. The server may provide a selection of a plurality of pre-registered digital screens located in public venues. The server may receive user input, via a user device, selecting one or more of the pre-registered digital screens. The server may receive user input, via the user device, identifying a message to be broadcast on the selected one or more screens. The server may send the message to the selected one or more screens in a queue for broadcast during a broadcast time slot.

### CROSS REFERENCE TO RELATED APPLICATION

This application claims the benefit of U.S. Provisional Patent Application No. 61/578,051, filed Dec. 20, 2011, which in incorporated herein by reference.

### FIELD OF THE INVENTION

Embodiments of the invention relate to applications or “apps” to direct messages from one or more mobile devices to a secure server where they are reviewed, encrypted, archived, and broadcast over one or more proprietary or licensed public screens, such as, television screens or electronic billboards.

### BACKGROUND OF THE INVENTION

Current broadcast applications, such as Facebook and Twitter, allow a user to broadcast messages to recipients. However, to receive broadcasts from the user, such broadcast applications typically require the recipients of the message to subscribe to the user's account. Other broadcast applications, such as web logs (blogs), allow a user to post messages. However, access to blogs must still be initiated by readers.

Currently there exist non consumer-initiated direct broadcast applications for a consumer to broadcast a message to a mass market without the recipients of the message taking some action to initiate receipt of the message.

### SUMMARY OF THE INVENTION

Embodiments of the invention may provide a system and method for broadcasting media comprising a server. The server may provide a selection of a plurality of pre-registered digital screens located in public venues. The server may receive user input, via a user device, selecting one or more of the pre-registered digital screens. The server may receive user input, via the user device, identifying a message to be broadcast on the selected one or more screens. The server may send the message to the selected one or more screens in a queue for broadcast during a broadcast time slot.

Embodiments of the invention may provide a means for both individuals and businesses of any size to digitally broadcast their message to a large audience. Embodiments of the invention may include:
A mobile application (an “app”) to provide functionality to users for broadcasting media to one or more remote screens or display devices. This app may be operated by users and enables them to share their thoughts and creations in the form of media (e.g., text, video and/or images) with audiences accessible in selected target venues.
A screen or display visible in public and/or private venues, e.g., with large crowds of consumers. Screens may include for example large digital billboards in locations such as Times Square, scoreboards at sporting venues, electronic screens in bars, nightclubs, large hotels, airports, transportation centers, and the like.
A new local advertising channel that allows any size business to utilize social media communications techniques to effectively gain greater visibility. Embodiments of the invention may target specific locations, users and promotions, e.g., with immediacy.
An application operated over the Internet and enabled using cloud computing to provide real-time updates to software and capabilities.

Embodiments of the invention provide both a product and a service. The product may include an intuitive mobile application to direct a message from a mobile device (or a website) to a secure server where it is reviewed, encrypted, archived, and broadcast over one or more proprietary or licensed television screens or digital electronic billboards.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system for broadcasting user messages over a network of screens according to an embodiment of the invention;

FIG. 2 schematically illustrates a workflow for broadcasting user messages over a network of screens according to an embodiment of the invention; and

FIGS. 3-9 are screenshots of a user interface displayed on a user device according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may allow for efficient distribution of messages or other media, via for example a delivery network of displays, such as, monitors or screens for video or multi-media messages.

Embodiments of the invention may allow a user to broadcast a message in text, photo, video or any other format over existing mass market communication channels with little or no production preparation, wait time, expense, or commitment.

Messages may be displayed in time slots, for example, lasting a predetermined time interval, such as, thirty seconds. Messages may be displayed, for example, as a continuous stream ordered in a first-come-first-serve basis or may be designated to specific time slots. In some embodiments, where messages are integrated into regularly scheduled programming, the messages may be scheduled at pre-designated times between programming slots.

Embodiments of the invention may provide functionality using a proprietary mobile application (an “app”). The app may be downloaded and installed in any mobile device (e.g., a smart phone, tablet, laptop computer, etc.) or any other web-enabled hardware. A user may operate or interact with the app to connect the mobile device user to a server providing broadcast services.

The server may be connected to a screen or a network of screens registered with the app service. The user may send the server a message to be broadcast, and the server may broadcast the message to recipients or viewers via the network of screens. The app (along with a counterpart website) may act as a portal to the service's delivery mechanisms, and ultimately to its network of electronic screens and additional services such as user/member archives” (or the like).

Embodiments of the invention may use web service protocols to facilitate the transfer of data and content. Web service protocols may provide a standardized means for integrating web-based applications, for example, a front-end or client-side mobile application and back-end or server-side system software. Web service protocols may use flexible and open standards such as Simple Object Access Protocol (SOAP) using an Extensible Markup Language (XML) format to tag and transfer the data/content collected on the mobile device and to deliver related responses from the server. Such communications may operate using any type of browser or operating system, thereby eliminating compatibility concerns.

In some embodiments, the mobile device may include a Global Positioning System (GPS) or other geo-location mechanism. When the application is launched or initiated, the application may trigger the GPS module to send the physical location or coordinates of the mobile device to the web services program, for example, operating at the back-end server of the system. The web services program may then return related information, such as, a list of registered screens located within a given or predetermined radius of the phone's current location. If the mobile device does not have geo-location capabilities, the user may manually enter a zip code or local address and/or a desired radius of screens, according to which the web service may return associated screen locations.

In one embodiment, a screen location interface may display the screen locations as a list, for example, with adjacent columns providing details associated with each screen, such as, address, distance from current location, wait time for broadcast, cost of broadcast, etc. The user may sort the list of screens based on any such detail, for example, such as cost (from low to high), distance (from near to far), etc. In another embodiment, the screen location interface may display the screen locations as icons or symbols on a map. The map may be an interactive or “hot” map, with which users may select, touch, or click on a location to view screen details. The user may select a screen scheduler interface, e.g., via a link in the list or map display.

The screen scheduler interface may allow the user to schedule a message to be broadcast at each screen location. Screens may be scheduled individually or in groups, for example, where a single proprietor owns a group of two or more screens. The scheduler may display available time slots for the particular selected screen's location and/or allow the user to select a time slot for the broadcast. Once selected, the user may upload broadcast content or may refer to previously submitted content.

In one embodiment, after a time slot is selected, the time slot may be reserved for a maximum predetermined time period (e.g., five minutes) for content to be submitted, payment to be made or the transaction to be otherwise completed, after which the time slot may be released back into the pool of available slots. In other embodiments, content and/or payment may be made before the time slot is selected so that no reserve time is needed.

Time slots may be sold to users in any manner, for example, individually or in groups or packages of multiple slots. Time slots may be sold at an absolute price or for a highest offer in an online auction environment. Users may pay for messages in any manner, for example, using a secure payment service, by credit card, etc. In some embodiments, time slots may be sold as a “freemium” or a free base rate for a basic message (e.g., text only) or predetermined time and where the user is charged only if the message includes additional content (e.g., pictures/video) or extends beyond the predetermined time.

If the transaction is successfully completed (e.g., content is submitted and payment is made within the allotted time period), the broadcast content may be transferred to an approval system, e.g., via the web service program, to undergo an approval test. Once in the approval stage, the submitted content may be automatically and/or manually analyzed, for example, based on predefined criteria, e.g., to prohibit inappropriate content, such as language, violence, etc. The proposed broadcast content may be either approved or rejected for broadcast, or, in some embodiments, the proposed broadcast content may be assigned a rating or score allowing broadcast at some (but not all) screens pre-designated for such content ratings, as discussed below. Approved broadcast content may be moved to a final publishing queue (e.g., a separate queue for each screen). When broadcast content is rejected, the broadcast content may be discarded or marked as such, an automatic notification may be sent informing the user, and/or the reserved time slot may be released. In some embodiments, approval may be automatically provided if the broadcast content was previously submitted and passed the approval test.

The network of screens used to display messages may include any screens, such as, outdoor electronic billboards, dedicated or all-purpose screens located in public locations, such as, clubs, bars, malls, hotels, stadiums, etc. Screens may be located anywhere, indoors or outdoors, and in both public and private locations. Any proprietor or owner may register a screen to join the network, for example, upon satisfying system standards.

In some embodiments, all screens that are registered in the network may be assigned a unique profile. The profile details for the screen may include, for example, location, venue type, target audience, screen content rating (e.g., CH, Y, G, A, UR, as discussed below), aspect ratio or resolution, screen dimensions, screening protocols for each message, any special time slot considerations, and price per broadcast slot (e.g., including unique pricing based on criteria such as location, time of day, day of the week, holidays, length of message, source of message, content, etc.). In some embodiments, the proprietor may provide the profile details, which may be independently verified. For example, the proprietor may set the broadcast price or, alternatively, the price may be set or at least limited to a range set by the service provider.

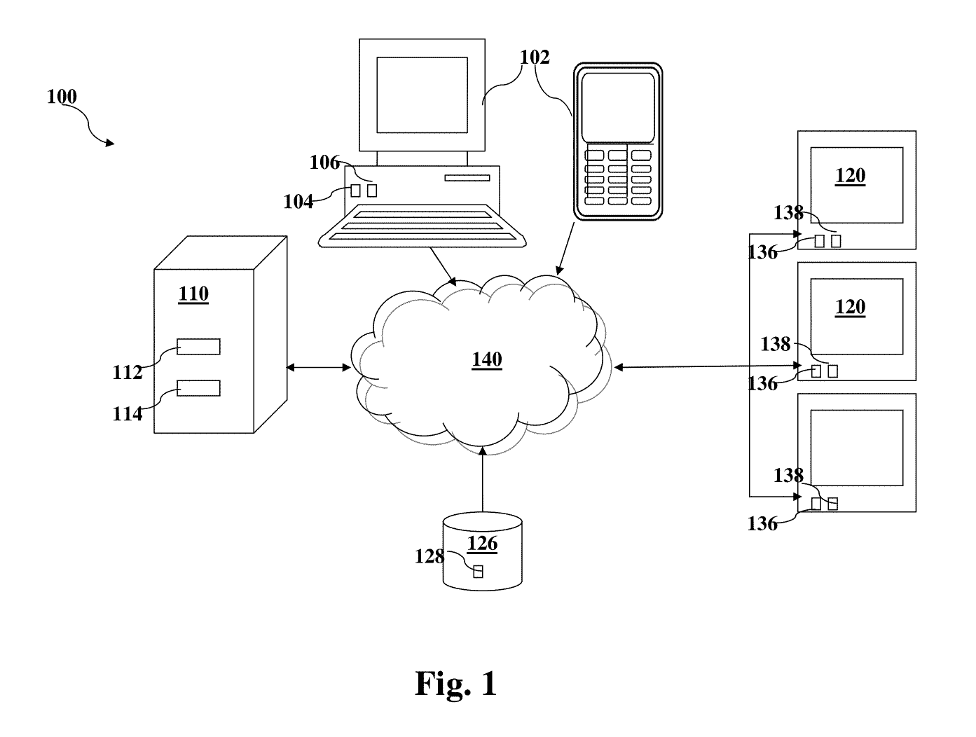

Reference is made to FIG. 1, which schematically illustrates a system 100 for broadcasting user messages over a network of screens 120 according to an embodiment of the invention.

System 100 may include a server 110 for interacting with a plurality of user devices 102 and managing a plurality of network of screens 120 and a message database 126. Server 110 may include a processor 112 and memory unit 114 for managing broadcast services and messages, e.g., using a web service program.

User devices 102 may have a broadcast application provided by server 110, which may be installed locally on user devices 102 or may be streamed remotely from server 110. The broadcast application may allow a user to design or upload messages or other broadcast content, select target screens from network of screens 120 and pay for their broadcast. User devices 102 may include, for example, computers, telephones, cellular or mobile devices, and/or SMS or text message enabled devices, etc. Users may operate user devices 102 over one or more networks 140 (e.g., such as the Internet or World Wide Web, radio or telephone networks).

A screen operator or proprietor may add screens 120 to the network of screens 120 by registering with server 110, for example, by providing screen profile data. Server 110 may run a certification and verification process to determine whether or not to accept new screens 120 into the existing network of screens 120.

Server 110 may receive broadcast content, for example, uploaded from user devices 102, retrieved from database 126, and/or created by the user at a design interface hosted by server 110. Message database 126 may store messages currently or previously broadcast.

Server 110 or database 126 may include a cache 128 to store the most recently used messages from database 126, for example, in order to increase the speed of repeatedly retrieving the same message. Server 110 may store the retrieved messages in local memory 112. Server 110 may use processor 114 to run a content verification test to either approve and queue the message for broadcast or reject the message based on specified criteria and release the time slot for use by another user.

Screens 120 may include any digital screens or display, such as, digital billboards, televisions, computer screens, tablets, projectors, radio, etc. Typically, server 110 may generate an ordered queue of messages prompted for display and streamed directly to screens 120. However, in some embodiments, screens 120 may include or may be connected to a memory 138 and a processor 136 to locally store and order, respectively, messages from server 110 (e.g., transferred in unordered bundles).

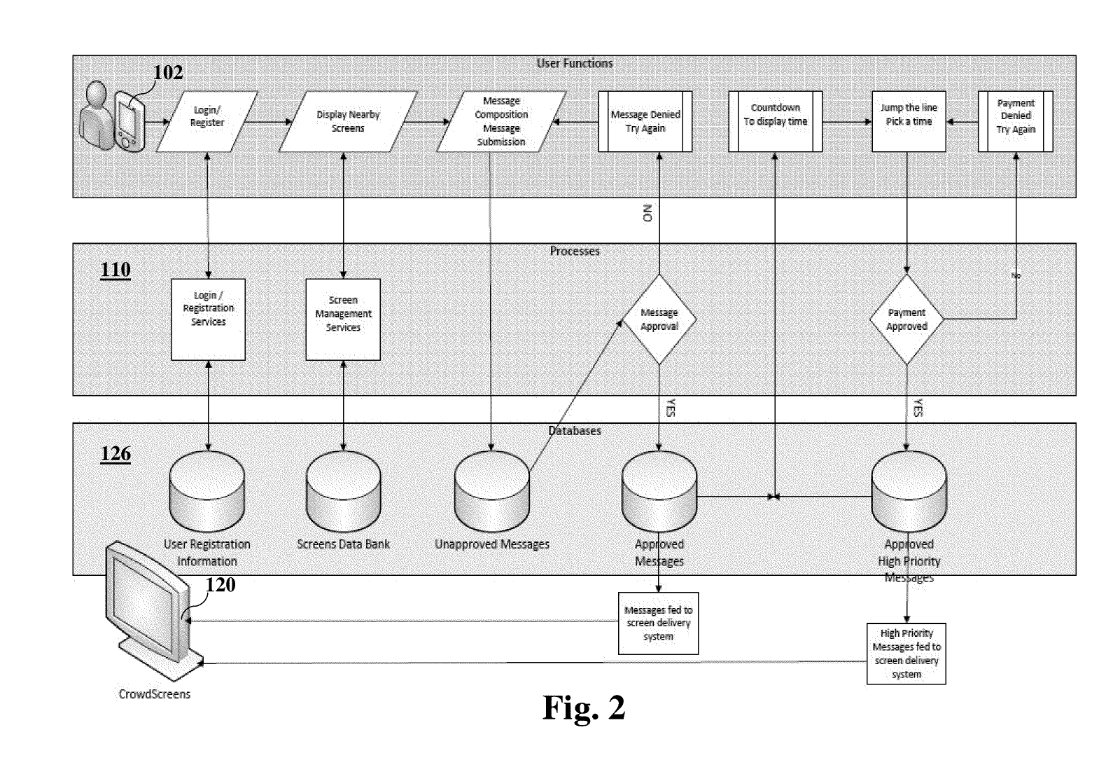

Reference is made to FIG. 2, which is a workflow illustrating a method for broadcasting user messages over a network of screens 120 according to an embodiment of the invention. The workflow includes several steps, and the user may be guided through them via instructional interfaces that appear on user's device 102. The method of FIG. 2 may be executed using the devices of FIG. 1, such as, user devices 102, server 110, screens 120 and message database 126.

Once a user has downloaded a broadcasting app from server 110 to user device 102, the user may log-in to the application using a unique username and password associated with the user account. At that stage, the user may begin posting messages.

User device 102 may identify the user's current location (e.g., using a GPS installed in user device 102) and display the closest available screens to the user. The user may have the ability to manually select a screen location (if user device 102 is not GPS enabled or the user prefers to broadcast in a location different than the user's current location). The user's location may also be matched to local retailers and other marketers in order to offer the user products or services in a viable geographic vicinity. The broadcasting app may then flexibly communicate those offers from server 110 to user device 102 while the user's broadcast message is being processed.

The user may enter, upload, design or otherwise create or select the message or content proposed for broadcast via user device 102, for example, including photos, animations, video clips, audio, etc. User device 102 may transfer the message to server 110 where the message may be analyzed for content.

Server 110 may analyze the message content in order to rate the message's content for broadcast or otherwise determine its eligibility for broadcast on the chosen screen(s). This screening process may be an automated or computer-based step wherein the message is analyzed for certain sounds, language, images and other programmable prohibitions. If the message is deemed unacceptable, the user may be notified. If there are no automated warnings noted in this process, the message may then advance to be analyzed by a live employee that may inspect the message visually. The visual inspector's interface may display the message and the individual screen protocols simultaneously. If the screens are rated, the message content may be analyzed according to the rating protocols assigned to each particular screen. Alternatively, if the user has selected more than one screen for the broadcast, the strictest clearance protocols from among the screens selected may be applied to the message for all screens.

If the content is in compliance with content protocols, server 110 may approve the content of the message and transfer the message to screens 120 for broadcast. However, if the message includes non-compliant or prohibited content, server 110 may reject the message and the message may be discarded.

Once approved, the message is queued for broadcast. A countdown clock may be displayed on the user interface. In addition, a live feed of the crowd assembled in front of the screen may also be displayed. Although the broadcast times for each message may be ordered as a default based on the order in which they were received, in some embodiments, the user may be provided with an option to reduce the wait time until broadcast (move ahead in the queue) and/or to select broadcast time(s) (e.g., pre-set times already selected by other users may be blacked-out). The server may reschedule the broadcast times and queue order to accommodate user requests for sooner or pre-set times of broadcast, for example, by assigning a scheduling priority or weight to those messages.

The broadcasting application (app) may be supported by a website operated via server 110. The website may allow users without mobile devices to access the broadcasting application. The website may also manage and archive the entire body of messages in a searchable database, from where broadcasts may then be streamed. For camera-equipped screens 120, the camera may capture video of crowds witnessing the billboard or screen (e.g., to gauge reactions, popularity, etc.). In this way, broadcasting may be bi-directional, for example, the user sending messages to the recipients using screens 120, and video of the broadcast viewed being sent back to the user using screen cameras. Thus, the user may view video of the user's message being viewed as it appears on a billboard. A user may implement such functionality by downloading a monitor app (or monitor functionality integrated into the broadcasting app). In some embodiments, server 110 may provide archived footage on the website (e.g., archived at database 128), where users may search for and display previously broadcast messages. In such embodiments, the user may view both the message itself, and if a camera-equipped screen 120 is utilized, a video of crowd footage during the time when the message was originally broadcast live (e.g., for a 30 second slot).

Delivering or broadcasting a message may proceed, for example, using the following steps: download the app, select the broadcast screen, and upload the message. In order to maintain security and privacy, the broadcasting app may incorporate various security techniques and protocols.

Each screen 120 receiving broadcasts may maintain a unique identity associated with a screen profile. That screen 120 identity may be password-protected, and may be changed periodically, for example, on a frequent basis agreed upon by the screen owner. Messages may only be posted upon entry of a valid password for each screen. Thus, the owner may give server 110 a valid password to allow messages to be broadcast on his/her screen 120. All messages that pass between the user and server 110 may be content and/or quality controlled, for example, by a computer in an automated/electronic phase as well as by a live human inspector in a manual phase, before the messages are broadcast or posted to a separate server. The message maybe encrypted in a format readable by the screen 120 at which it is broadcast.

Embodiments of the invention may be used for personal or commercial use. For personal use, a user may stream messages, such as, texts, images or personal videos, from their mobile devices or computers to billboards, televisions and screens. For commercial use, corporate and retail advertisers may establish accounts with server 110. A user (e.g., employed by or acting on behalf of the advertisers) may upload pre-produced materials (e.g. an existing 30-second commercial) or instant messages (e.g. “the XYZ restaurant in Times Square has open tables”). The broadcasting application may provide the advertiser with a communication channel that uses little or no production time or cost, and the flexibility of running a message specifically when desired. The broadcasting application may be connected to viewers via their mobile phones such that the viewers' locations may be known. In one embodiment, the broadcasting application may enable a commercial advertiser to target their message to viewers, e.g., by direct-messaging a viewers' mobile device, based on the viewers' locations. Accordingly, commercial advertisers may be able to quickly reach people within a sufficiently small (e.g., “walkable”) radius of their business location.

Embodiments of the invention may broadcast messages in “real-time.” For example, a user may finalize a broadcast transaction or select a “broadcast” button (e.g., for one-step broadcasting) and their message may be queued for display instantly or substantially soon thereafter. It may be appreciated that broadcasting “real-time” may refer to queuing a message for broadcast on a screen within a predetermined time or time delay (e.g., 10 seconds to one minute) after the broadcast is purchased or finalized. It may be appreciated that because screens are shared, although a message may be queued nearly instantaneously, typically a message may wait until the next available time slot to be played or broadcast.

It may be appreciated that although certain devices and functionality are assigned to “users,” “broadcasters,” “viewers,” “recipients,” “proprietors,” and “owners,” such functionality may be implemented by any users in any environment.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller (e.g., such as processor 114 of FIG. 1), cause the processor or controller to carry out methods disclosed herein.

Embodiments of the invention may provide a mobile application to direct a message from a mobile device to a secure server where it is reviewed, encrypted, archived, and broadcast over one or more proprietary or licensed television screens or electronic billboards. Embodiments of the invention may use Software-as-a-Service (SaaS) solutions providing web-based software applications. In conventional systems, software installed on a user device may become outdated or obsolete. In contrast, Software-as-a-Service products operated according to embodiments of the invention may automatically update software in a “cloud” computing environment with the latest version and may obviate the need for hardware infrastructure.

Social media platforms such as Facebook allow one person to communicate with dozens or even hundreds of users at the same time, and through them, to an exponential number of users linked together through social networks. However, to receive a message a tangible personal connection is necessary in conventional systems, and the messaging may only be viewed within the confines of the social media community. Internet communications such as blogs allow a user to post messages but exposure to the blog must still be actively initiated by the reader.

Embodiments of the invention may provide users with an easy platform to communicate with a wider audience and with the flexibility to target viewer groups such as mass audiences.

### Mobile Application-Driven Communications Platform

Broadcasting according to embodiments of the invention may be enabled through a proprietary mobile application (an “app”). The app may be instantly downloaded to any mobile device (e.g., an iPhone, Blackberry, Droid, etc.). The app may wirelessly connect to the one or more screens (e.g., screens 120 of FIG. 1), such as, electronic billboards, terminal televisions, etc. The app allows any user to use a wireless device (e.g., a smart phone, tablet device, etc.) to connect via the Internet to a server to broadcast a message on the one or more screens (e.g., an electronic billboard in Times Square) for a specified amount of time (e.g., seconds). Messages may include any media format, such as, text, images, graphics, videos and/or any digital information, which can be loaded onto a website and broadcast on a digital screen.

Embodiments of the invention may use web service protocols to facilitate the transfer of data and content. Web-based applications, such as, the mobile application, may be integrated on the front-end with the system software on the back-end or server side. Web-based applications may use flexible and open standards such as XML (Extensible Markup Language) and SOAP (Simple Object Access Protocol) to tag and transfer the data/media content collected on the mobile device, and to deliver related responses from the server. Any browser or operating system may be used.

Broadcast content may include, for example, simple text messages from the personal (“Julie, will you marry me?”), to the political (“I'm a fan of Joe Smith and I'm voting for him!”) to team spirit (“Let's Go Yankees!”) or anything else someone wants to share with crowds of people. Image-based messages might feature families on vacation, students on field trips, people seeking employment, artists plugging their artwork, favorite pets, items for sale, couples out on the town, etc. The message content may be uniquely created by the user.

Video feeds as well as may also be broadcast. In some embodiments, audio may be broadcast on an audio-enabled device (e.g., viewing the message on a website running on a computer with speakers) or, in other embodiments, broadcasts may not include audio (e.g., viewing the message on a billboard or other screen).

Customized graphic templates (birthday greetings, congratulations, proposals, etc.) or animations allow more sophisticated and professionally produced pieces to be broadcast in the same manner. These types of digital assets could showcase the work of artists or designers, or simply produce a considerably stronger visual for what would otherwise be a simple text-based or static image-based message.

In some embodiments, viewers may comment on broadcasts, for example, prompting further comment from additional viewers and replies from the original poster. Embodiments of the invention may also display interactive games or tools for users to communicate from different terminals in a screen network.

Broadcasts may include widgets or programming elements that display information, such as an advertisement, e.g., in a text box or a window, within another graphic element. Embodiments of the invention may use widgets as the basic visual building blocks of broadcasts that allow users to generate interactive features, such as instant polls, games, contests, and the like.

### Website Portal

Embodiments of the invention may be fully supported by a public-facing web portal. The portal may store the same application and broadcasting functionality provided to mobile devices, but packages it within a much larger suite of account, advertising, and administrative functions. Access to these areas may be granted via permissions and security settings accessed, for example, via a ‘Log-In’ web page.

### Web Site

When site visitors enter the website, they may be presented with basic options to view a screen (or the content thereof) or to broadcast a message. Template or sample broadcasts may be provided. Users may select any of the various public-facing screens and may view content currently being broadcast in real-time or may play-back a log or stream of what has been broadcast in the past (or is scheduled to be broadcast in the future), for example, to familiarize users with screen activity

### Secondary Consumer Portal

Users may access the website portal to upload messages from anywhere in the world. The portal may provide the same broadcasting features to any Internet-accessible device as the mobile app provides to mobile devices. These features may include a searchable archive of messages that have been broadcast, an application to review messages or broadcasts previously posted by the user or others or on any selected screen. Users may be able to forward archival broadcast links to friends and family who may not have seen the original broadcast. Additionally, the archive may allow registered users to post clips to YouTube and other social media sites. Embodiments of the invention may also allow the user to store and organize digital material in a repository, for example, for reuse in future broadcasts.

Another feature in the consumer portal is a “live” view of camera-equipped screens. Certain screen locations may have digital cameras pointed at the viewers (or equipped with motion sensors to automatically move to image the largest viewer group). Some embodiments may enable computer-vision technology to estimate the size of a crowd, for example, to provide the broadcaster with viewer statistics or to broadcast only if the size of the crowd exceeds a predetermined minimum number of viewers. The video feed from the screen-mounted cameras may be available (and archived) on the website. Users who post a message remotely may be able to view not only the messages but the crowd's reaction, for example, by viewing a split screen on the website (one side of the screen displaying the broadcast; the other side of the screen displaying the camera view of the crowd). Users may also provide an option to share the live view with user contacts, so others can also view the crowd's reaction to a broadcast of a particular message.

### Primary Advertising Portal

The web portal may serve as the main hub for advertisers. Because ads are typically generated in a business/office environment, in some embodiments, the web portal may provide more flexibility and greater storage and processing power than a mobile app, although in other embodiments a mobile app may also be used.

Advertisers may be asked to register in the system by submitting basic business details and payment (e.g., via wire transfer, ACH debit, credit card, etc.). Once registered and logged in successfully, the full advertising platform may be at their disposal. Advertising slots at each screen locations maybe assigned in parallel to (free or relatively cheaper) consumer messaging. In some embodiments, advertising slots may take priority over consumer messaging and available consumer messaging time slots may be affected by advertising volume/activity. Advertisers may select a screen manually from the full list of active locations, and upload their messaging in one of several ways. Text-based advertisements may be entered directly in the system, while pre-produced multimedia messages may be uploaded from an advertiser device via a wired or wireless connection. Advertisers may also be given the option to use an advertisement template, for example, configured in a variety of layouts, which may combine text, images, graphics, and/or video, to allow advertisers to create advertisements quickly. Because each screen location may have its own physical size, orientation, resolution and layout, the specifications and templates offered may vary by screen location.

Advertisers may maintain account balances. A number of tiered packages may be offered to reduce financial transactional volume, and to automate and expand the reach of advertisements. Intuitive interfacing may guide advertisers through the ad placement process, offering a range of choices that start with a single, one-time ad and end with packages that broadcast their ad across hundreds or even thousands of screens.

### Administrative Control Panel

The web portal may store administrative utilities for registering and configuring digital displays, managing open broadcast space, managing system messaging, and configuring other infrastructure elements. A screen may be registered, configured, and tested before it becomes an available location in the screen network. Screens may be for example outdoor electronic billboards, televisions or dedicated screens located in environments such as clubs, bars, malls, hotels, airports, stadiums, etc. Broadcasts may be deliver messages to any digital screen once that screen has been registered and verified within the system. Screens that are registered may be assigned a unique profile and identification (ID). The profile describes the location of the screen, the screen owner, the physical screen specifications, the technical specifications, installed software, hardware or operating system, the expected audience, the screening protocols for each message, any special time slot considerations, and the pricing assigned to each screen (including unique pricing based on criteria such as location, time of day, day of the week, holidays, length of message, source of message, content, etc.)

An administrative portal may load default and/or internally-driven messaging. The system may load default messages that may be broadcast during any unfilled broadcast slots for either consumer messaging or advertising. Default messages maybe filled with “seeded” personal messages intended to start a dialog, express an opinion, provide exemplary messages, sponsor/affiliate advertising, promotions, tips/insights, games, polls, contests, 311 broadcasts, or advertisements for the screen messaging system itself.

When extremely heavy traffic is anticipated (such as New Year's Eve, certain holidays, when a local sports team is involved in a playoff series, etc.), administrators may pre-program messages for specific time windows. The cost of message slots may also be adjusted based on demand. For instance, while messages may be provided for free (or at a relatively reduced rate) for consumers, there may be occasions when a fee to post a message may be charged (or increased) during times of unusually high demand, such as New Year's Eve in Times Square. Payment mechanisms may be used as are known in the art, for example, for purchasing apps and charging other expenses though a mobile phone.

The administrative portal may also be responsible for configuring and managing automatic messaging generated by the system. Automatic messaging may be sent via email or pushed directly through the app or web portal and may include, for example, confirmation messages for consumer and advertiser registrations, password retrieval functions, message placement confirmations, asset incompatibility notifications, message approval confirmations, message rejection notifications, message broadcast confirmations, account balance and replenishment reminders, credit card expiration reminders, system maintenance notifications, and general system errors.

### System Workflow

### Download & Registration

The mobile app may be downloaded via the Internet, e.g. from select application marketplaces. Once the app is successfully downloaded on a mobile device, the user may register, for example, by providing an e-mail address, a log-in user name and/or password, accepting certain terms and conditions, etc. The system may then provide the user with a unique password assigned to their account (e.g. the number of their mobile device). Once registered, the user may immediately begin posting messages.

Consumer messaging may include sending text, graphic and video messages and may be free for consumers. Typically, messages are broadcast in the order that they are received at the server. However, the system may allow consumers to broadcast out of order or at a selected time slot. If a consumer requests to post a message at a pre-set time in the future, or if their message is time sensitive and they want to move to the head of the queue, the system may enable such out-of-order broadcasting, for example, if the user pays a fee. This model is known as “Freemium,” where a product or service is offered for free but certain enhancements or other premium services are available at a cost. Any costs thus applied will be charged to the user, for example, via a payment method approved during registration.

### System Flow Chart

When the mobile app is launched, the user may be automatically logged in and taken right to the main web page. The user may be automatically logged-in using identifying data stored in a cache memory entered during their initial set-up. Once the app is opened, GPS-enabled mobile devices may automatically detect and relay the physical location of the mobile device to a web services program that runs on the back-end server of the system. The web services program may then return location-specific information to the mobile device. For example, including information identifying screens located within a selected or predetermined radius of the phone's current location (displayed in a map or list). If GPS is not enabled on the mobile device, the user may manually enter a zip code or local address and/or desired radius, and active screen locations may be returned accordingly. Screens may be displayed in a list sorted by a selected or predetermined condition, such as, from closest to furthest away, most popular or greatest viewership, screen size, soonest available time slot, advertising slot cost, etc. Upon receiving a user-selection of a screen, the system may retrieve a map of that screen and provide access to the content input interface and scheduler for that screen location.

Once a screen location is selected, the user may generate or upload a message using text and/or other media, such as, graphic images or video. The user may be prompted to (again) agree to terms and conditions, which may change over time. The user may then select a “post” button and the message may be sent to the system server and placed in a queue to await approval. The system server replies to the user with an estimated wait time for their broadcast to air. The system is designed to receive, verify and broadcast a message. The process typically takes a few minutes; however increased user demand during peak periods may result in delays. The anticipated broadcast wait time and/or a countdown clock may be displayed to the user. The user may be provided with an option to broadcast sooner and reduce the wait time (e.g., by selecting a “Jump the Line” button) and/or to select broadcast time(s) (e.g., by selecting a “Pick a Time” button and entering the desired time(s)—pre-set times already selected by other users may be blacked-out). These options may require a fee automatically charged via the user's registered payment method.

Approval of messages may be executed in a two-step process, although other or additional processes or steps may be used. Messages are first censored using a database to filter out messages including inappropriate or objectionable language. If passed, the message maybe visually inspected by an employee or automatically inspected by an intelligence engine to double-check the database screening and to prevent any messages with objectionable graphic elements from being posted.

Once a user's message (and, if selected, their preferred broadcast time) is approved, the content may be moved to a final publishing queue where the message is examined for compliance with predefined publishing criteria established for the selected screen. If the message is rejected for failing to comply with the publishing criteria, the user may be notified, e.g., via SMS message or email, and may be prompted to revise their message and try again. If a time slot had been reserved for that message, the time slot may be released for general use.

### Mobile Application Consumer Functionality

As described in reference to FIG. 2, there are several basic steps in the broadcasting process. The mobile app may be used to guide the user through them via simple instructional screens that appear on the mobile device (e.g., user's device 102 of FIG. 1). The following sequence describes these steps and provides a look at how the app might appear on the screen of a user's mobile device.

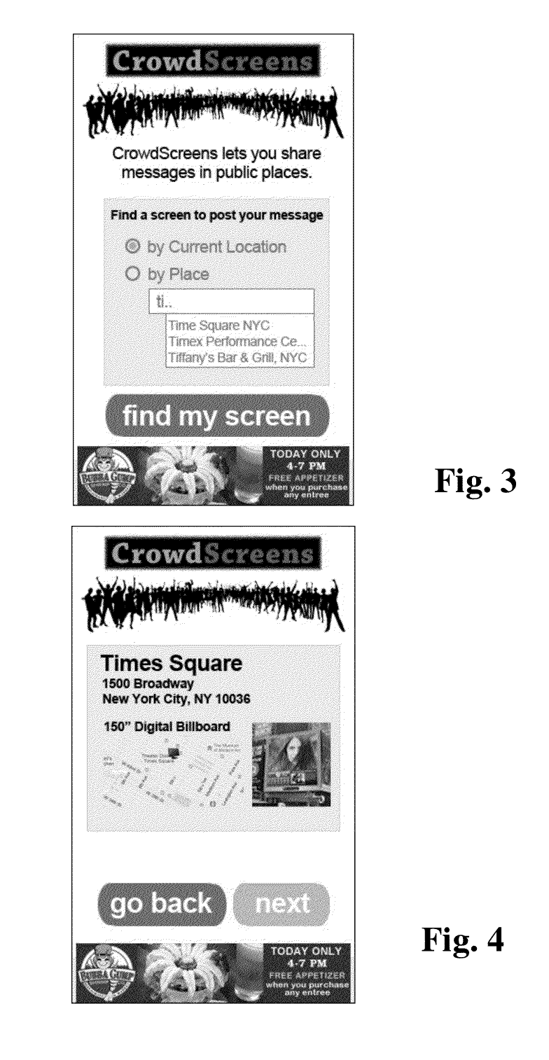

Reference is made to FIGS. 3-9, which is a screenshot of a user interface displayed on a user device (e.g., user's device 102 of FIG. 1) and operated by a system server (e.g., server 110 of FIG. 1). The user interface is typically provided by a mobile app displayed on a mobile device; however, the interface may also be provided via a standard web page run on any mobile or non-mobile device.

Prior to posting messages, the user interface may ask a user to register, e.g., by entering a social media identification or log-in or by providing an email address, in a one time registration procedure. Once the user's registration data is collected, the user will be free to use the system at their discretion.

The user interface shown in FIG. 3 allows the user to search, identify and select one or more screen(s) to display their message, e.g., as enabled by the system server. If the user device is not GPS enabled, the app may identify the user's current location through the GPS and identify the closest broadcast screen, e.g., via a list or map (as shown in FIG. 4). Additionally or alternatively, a screen search field or manual entry field may be provided for the user may manually select a screen or screen location (e.g. if the GPS in their device is disabled or otherwise inactive). The user's location may also be matched to local retailers and other marketers with products or services to offer in close geographic proximity. The advertisement may be displayed, e.g., as a widget in the messages (e.g., in the lower portion of the viewable app interface and/or the screen display). Advertising may be static so as not to detract from the overall message broadcasting experience, or alternatively may be dynamic such as an animation or video.

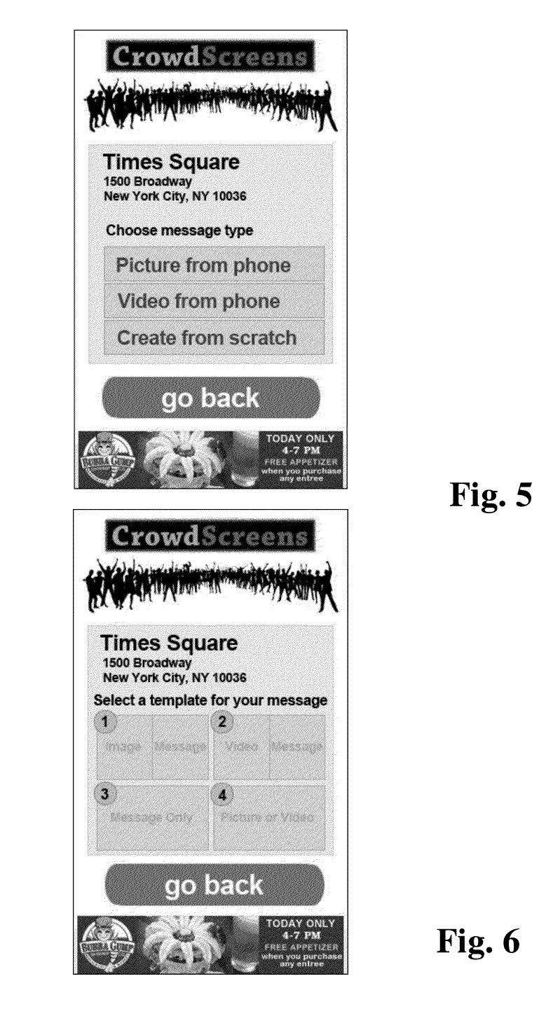

After the user selects a specific screen at a location, the user interface shown in FIG. 5 may offer a more detailed view of that particular screen. The screen's details may be provided (e.g., address, screen ID, etc.), and/or a “hot map” of the physical screen location. Based on this view, the user may elect to continue to the next step or to return to a previous interface (FIG. 3 or 4) and select an alternative screen.

Once the screen is selected, the app may then prompt the user to generate or upload a message or to select from set of message types, for example, using the user interface shown in FIG. 6. Message types may be varied, and may include pictures, videos, or messages created from scratch on the app itself (such as text messages or hybrid text/multimedia messages) as well as saved or downloaded media. In one embodiment, the user may select a “Special Occasion” type or choose from one of the basic message types.

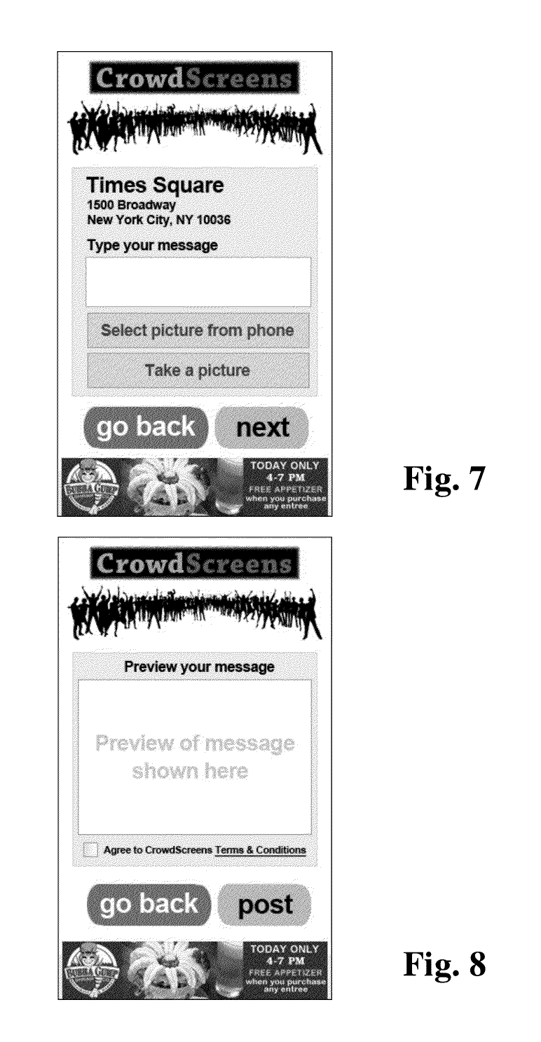

If the customized “create from scratch” message type is selected, the app may display the user interface shown in FIG. 7. The user may operate the user interface to select a template from a series of message templates. The templates range from text-only to hybrid layouts that combine text and multimedia. The template layouts may be standardized, and may be subject to the physical orientation of the specific screen selected in the beginning of the process. For example, a vertical screen and a horizontal screen may each have their own specific templates. Alternatively, a single template may be adapted to conform to any orientation, size or resolution configuration.

In the example shown in the FIG. 7, the user has selected template (1) from the four templates shown in FIG. 6. This template includes both text and an image. The user may type their message into the text field e.g. as though they are sending a normal text message. Template (1) includes an option to attach a photo. Choosing ‘Select picture from phone’ may allow the user to browse their local picture library or a private or public repository stored in a “cloud” or remote database, and select an image for display. Choosing ‘Take a picture’ may launch a camera on the mobile device, which upon capturing an image (and accepting the image), may automatically insert the image into the template for display.

The user interface shown in FIG. 8 may display a preview of the message. At this stage the user may return to the previous interface to edit the message (using a ‘go back’ button), or elect to post/broadcast the message via a ‘post’ button (subject to approval). The user may also agree to the official terms and conditions, which provides the system authorization to approve or reject the message.

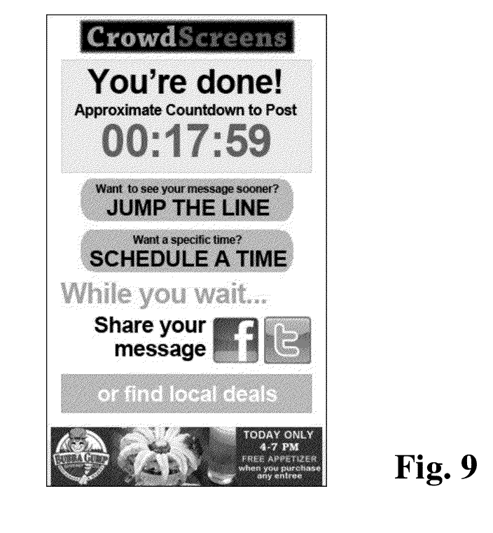

Once the user selects the ‘post’ option (and upon approval of the message content), the server may automatically queue the message for display on the selected screen. The user interface shown in FIG. 9 may display a countdown clock indicating the waiting time until their message will be broadcast. For users who would like to display their message sooner, or for people who have specific timing needs, the app may provide users with options for reordering their message.

In one such embodiment, the user may elect to “jump the line” if they don't wish to wait for the full countdown. When a user chooses this option, the message may be moved forward in the approvals and/or broadcast queue and (potentially) and may be posted in front of all other messages that did not elect this option (e.g. but behind other messages for which this option was selected first). The user may receive a confirmation that relays the revised posting time. In another such embodiment, when a specific future broadcast time is desired, the user may select the ‘Schedule a time’ option. The system may automatically display available time slots based on month/day/time of day, and block time slots that are already reserved or in the process of being reserved. Both of these additional posting options may be subject to a fee that is charged to the user's account (e.g., a credit card they provided when they activated their smart phone, an apple iTunes account, etc.).

Once the message posting process is complete, the app may create further engagement by offering social media sharing buttons (for sites such as Facebook and Twitter) and links to local offers posted by advertisers.

### Website Portal User Functionality

### Consumer Functionality:

The website portal may include a application running a user interface. The user interface may include an action layer to prompt the user to select a screen. The user may be offered a plurality of available screens. Once a user has selected a screen, the user interface may prompt the user to register or log-in by entering identifying information such as an email address.

Once the user is identified, the user interface may offer the user options to either ‘post’ or ‘view’ messages. If the ‘post’ option is selected, the application may launch a browser version of the app. The website user may provide the same functionality as the mobile application, e.g., allowing the user to design their message, prepare text-based and/or multimedia messages. Once the message is submitted, the user interface may display a time-clock indicating the expected time slot for the message (subject to change due to other users or advertisers jumping the queue). In one embodiment, the user interface may offer the user the ability to request a sooner or pre-set time of broadcast. In another embodiment, the user interface may offer the user the ability to “lock down time,” which guarantees the user that their message will be displayed at the time indicated by the clock. To accommodate this locked time, the server may prevent other users from moving ahead of the locked time user or may still rearrange other messages, allowing messages to move ahead of the locked time messages only if another message is removed, to cause no net change in the locked time slot (or a minor change, less than a predetermined time of, e.g. 30 second).

Current systems schedule approximately 120 messages per hour and a typical a wait time of approximately 6 minutes for every 12 people posting at an earlier broadcast time; although other message times, lengths, schedules and capabilities may be used.

Subsequent user interface screens and application processes may be substantially similar to those provided by the mobile device portal. Once the message is approved and moved to the publishing queue, the user may be prompted to share their message in a social media environment, e-mail the post to contacts, etc. The user's computer screen may then display a feed from the screen where their message is scheduled to post. An option may be afforded to the user to toggle between the message board view and the crowd view (if the selected location has a camera to capture crowd reaction) or to view a split screen streaming both the screen view and the crowd view.

If a ‘view’ option is selected, the user may be shown a user interface that displays the nearest screen location in real-time. Selecting an alternate screen may cause the server to load a real-time view of that screen and/or of the crowd currently viewing the screen (if the screen is camera-equipped). The user interface may display archived messages broadcast of the featured screen. This stream may be displayed as a scrolling list of selectable 30-second increments or a slidably controlled stream that allows the user to slide forward and back in time with fine detail. If the user is already logged in to the system, an additional ‘View & Share My Messages’ option may be provided. This option may swap the content in the featured screen box and archive controls for that user's archived content, displaying the most recent activity by default. A ‘User Profile’ tab may allow the user to manage and edit account information such as an email address, credit card information, and a password. A ‘User Gallery’ tab may provide a repository for personal digital assets, along with the ability to create a folder structure to store them and use them in future broadcasts. If the user is not signed into the system, a ‘Log In’ button may prompt the user to do so.

### Advertiser Functionality

Advertisements may be embedded (e.g. as widgets) within the message screens or displayed separately from message broadcasts. Advertisers will be able to flexibly operate advertising broadcasts, e.g., via a direct URL or a footer link on the system web page. Advertisers may establish accounts through which they can upload pre-produced materials (e.g. an existing 30-second commercial) or instant messages (e.g. the XYZ restaurant in Times Square has open tables). The system provides the advertiser with a communication channel that requires little or no production time or cost, and the flexibility of running a message specifically when needed. Advertising slots may be priced according to the time of day that the advertiser chooses and the advance reservation time requested.

When an advertiser accesses an advertising area of the web portal user interface, the user interface may present the user with ‘Log In’ and ‘Register’ buttons for those with existing accounts or an immediate intent to register their business. A ‘Create An Ad’ option may also be provided on the advertiser user interface.

Once an advertiser elects to create an ad, the following steps may be executed.

In step one, the advertiser may be prompted to generate a design within the system or to upload a pre-existing design. If the user elects to generate a design within the system, the user interface may provide design choices such as a pure text-based messaging or any other of a wide range of system templates. The system templates may be provided, e.g., in wireframe form, allowing the advertiser to select a layout that works best for their message and materials. Text advertisements may be entered directly in the system via a text entry field. If a template is selected, a ‘Browse’ option located in each of the template sections may allow the advertiser to load digital assets from their personal repositories or public system-wide repositories. Advertisers may also elect to upload pre-produced messages that are compatible with the selected layouts. Specifications for each file type and size may be indicated, and incompatible material may not be accepted by the system.

In step two, the advertiser may select an advertising “plan.” A plan may include the following parameters: a screen and a schedule. The screen selection allows the advertiser to choose the screen (or screens) on which where their ads will appear. The schedule selection allows the advertiser to select the days and the specific day-times (early fringe, prime time, day time, etc.) when they want their ads to appear. Advertisers may select a single time slot and run a single ad (e.g., a local restaurant that wants to promote open tables on a Saturday night or a theater with unsold tickets for that evening's performance) or the advertiser may run the ad multiple times according to a defined schedule (e.g., every Thursday evening at 6:10 PM for three months, or every hour on the hour during Prime Time for three weeks). When the advertiser's account is set up, the system may create a “bank” of ads based on the number of “Ad Units” purchased. As the advertiser runs ads throughout the year, the cost of each ad may be deducted from that “bank”.

In step three, the advertiser may upload the ad (or ads) to the system server.

New advertisers may be required to create an account once the above steps are complete. Existing advertisers may log into their account at any point via a ‘My Account’ button.

### Security Protocols

At a base level the delivery system includes the following steps: downloading the app, selecting the broadcast screen, and uploading a message. In order to maintain security and privacy, the system incorporates various security techniques.

### Content Responsibility & Screen Identification:

As with any public broadcast, there is the potential for abuse. To address that issue, the system may identify any user device by an identification number or code, such as, a mobile number. Each screen receiving broadcasts may also be identified by a unique identification number or code linked to a screen profile. That identity may be password-protected, and may be changed. In one embodiment, messages cannot be posted without the current password for each screen.

Additionally, a complete rating system (see below) may set specific guidelines for message content, and each screen may require a firm rating at all times. Users may realize that certain content may not be approved for broadcast on screens with strict approval ratings and may instead select screens assigned a rating that matches their content and demographic.

### Rating System:

Each active screen may be rated, for example, using a system based on the MPAA ratings of movies and the parental guidelines adopted by the television broadcasting industry. These screen ratings appear on the following page. Additionally, when each screen is individually identified, its rating and the approval criteria may be adjusted to fit the market, or at the discretion of the screen owner, landlord, municipality, etc. Ratings may be assigned to each screen, for example, according to the following categories, although other categories may be used:
CH Content appropriate for all children. Whether the content includes text messages or photos/videos, the content appearing on a CH-rated screen is specifically intended for a very young audience, including children from ages 2-6. The content should not frighten younger children. There should be nothing that could be construed to be adult content in any way (e.g. language, nudity, drug use, or violence).
Y Content intended for a young audience, generally from age 7 to 13. Messages may include mild or comedic violence (cartoon/fantasy) or some combative violence.
G Similar to a G-Rated movie, G-rated screens may include content intended for all audiences and are the standard rating for screens appearing in public places such as malls or on outdoor billboards. A G-rated screen typically does not text or graphics that conveys violence, sex, nudity, drug use, or other material that might be deemed socially offensive by the general public.
AA Content may include adult language, themes of sexual or violent behavior, drug references and other suggestive copy, and photos/video with partial nudity or simulated sexual behavior. These screens are typically intended for use in private establishments such as bars and clubs, and are typically not intended for use in public spaces. Certain screens may change their designation at different times of day or other unique circumstances. For example, a private establishment's screen could be G-rated until a certain hour, and then become A-rated at a later hour when their clientele generally changes. Rating the screens in a private establishment is the primary responsibility of the screen owner.
UR Content that is unrestricted. There are typically no limitations on the content, in either text or graphics, that may be posted.

### Screening:

The screening period may be seamless to the user, as broadcast slots may be allotted in real time. As users reserve slots, the material is immediately put into the approval queue and, subject to approval, broadcast. A computerized software screener may automatically remove any messages with prohibited language, e.g., designated as offensive, or other attributes defined and denied. Messages may then flow to a human for manual screening. During especially busy periods, users may receive a message, e.g., via text, if the queue of messages has a wait time exceeding a predetermined amount before the upload is broadcast (e.g. greater than fifteen minutes). Rejected messages prompt the server to send a notice via the app or the website to inform users of any breach of protocols and encourage them to try again. The server may recommend changes to content to meet approval ratings or different nearby screen locations with compatible ratings.

When a broadcast is received in the approvals queue, the message may be screened according to the protocols that have been assigned to that particular screen. If the user has selected more than one screen for their broadcast, the strictest clearance protocols from among the screens selected may be applied to the message for all screens. This screening process may be computer-based, wherein the message is screened for certain language and other programmable prohibitions. If the message is deemed unacceptable, the user will be notified. If there are no warnings noted in this process, the message will reach a live employee who will screen it visually. The visual screener's interface may display the message and the individual screen protocols simultaneously. If the message is cleared for the intended screen(s), it will immediately be placed in the broadcast/publishing queue.

### Encryption:

All communication between the mobile app, the servers, and the screens themselves may be encrypted. Similarly, all web portal and back-end processes, including financial transactions and screener communication with the servers, may be encrypted. An encryption standard, such as, the Advanced Encryption Standard (AES) may be used. The encryption standard may use a fixed block size of 128 bits with a maximum block size of 256 bits. AES may use a key size of 128, 192 or 256 bits, and typically uses an asymmetric algorithm with two keys: one key is used to encrypt the data and the other key is used for decrypting the encrypted data to increase security.

Embodiment of the invention may also use Open Authorization (“Oauth”), for example, within content sharing functions. Many of the popular social networking applications (e.g., Facebook, Google, LinkedIn, Twitter, Vimeo, etc.) use this standard when their users share data. Oauth allows users to share private resources (e.g., photos, videos, contact lists) stored on one site with another site without having to pass on their related credentials (such as user name and password).

### Line Extensions

The system may include secondary resources such as the following.

Hardware: Instead of broadcasting on privately or independently owned and operated screens, in one embodiment of the invention, the system may provide and/or operate its own screens. In one example, the hardware may include a screen of appropriately size (e.g., 50″ or lager) hi-def digital with built-in computer hardware pre-loaded with the necessary software and with a unique system identification. The hardware may be ready to use after and the screen is connect to the Internet, e.g., via wired or wireless communication.

Ancillary software: Gaming software may be added as an interactive tool enabled on the screens.

Mobile Messaging: A data base of users may be collected according to their registration information and their usage information. A learning model may adapt the broadcast offers based on the learned behavior of the user.

### Screen Types

Screens may include digital billboards, televisions, computer screens, tablets, projectors, user terminals, workstations, electronic score boards, Internet radio, etc. Screens may include mobile billboards (a screen on a car or taxi or a billboard frame mounted on the truck bed, which is then driven around a specific route, or taken to a specific location and parked). Screens may be set up in areas with high pedestrian volume, including malls, sports arenas, college campuses, transportation hubs such as airports, travel centers including large hotel/resort complexes and tourist destinations.

Embodiments of the invention provide a social media tool facilitated by the integration of a mobile app and a digital screen. Embodiments of the invention provide a truly public social media facilitated by the integration of a mobile app and a digital screen. Embodiments of the invention provide a process of delivering a personal message from a cell phone to a public digital screen (such as an electronic billboard) that is managed by a mobile application.

Embodiments of the invention provide the display of text, images, and/or video on a public or private digital screen that is managed by a mobile app or website. Embodiments of the invention provide real-time message screening for the appropriate display of public social media messages.

Embodiments of the invention provide a process for getting a personal message from a mobile phone to a digital billboard, whereby that process is managed through the use of a mobile app. Embodiments of the invention provide a process for getting a personal message from a computer website to a digital billboard. Embodiments of the invention provide a process for getting a customized advertising message from a mobile phone to a digital billboard, whereby that process is managed through the use of a mobile app. Embodiments of the invention provide a process of getting a customized advertising message from a computer website to a digital billboard.

Embodiments of the invention provide a process that allows commercial advertisers to directly broadcast an advertising message on an immediate, as needed, or pre-planned basis to a digital billboard via a computer website or mobile app. Embodiments of the invention provide a process that allows consumers to directly broadcast a personal message on an immediate, as needed, or pre-planned basis to a digital billboard via a computer website or mobile device app.

Embodiments of the invention provide a process of dynamic queuing that assigns a broadcast ranking to consumers who have posted a personal message based on their proximity to the broadcast vehicle. The process of dynamic queuing that may determine the length of time a message will be broadcast based on the number of messages waiting to be broadcast. Embodiments of the invention provide a process of two-way communication that provides the ability for an advertiser to communicate with a consumer—and the ability for a consumer to communicate with an advertiser—facilitated by a mobile app that interacts with placements on a public digital screen.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A system for broadcasting media comprising:
a server to:
provide a selection of a plurality of pre-registered digital screens located in public venues;
receive user input, via a user device, selecting one or more of the pre-registered digital screens;
receive user input, via the user device, identifying a message to be broadcast on the selected one or more screens; and
send the message to the selected one or more screens in a queue for broadcast during a broadcast time slot.

2. The method of claim 1, wherein the server is to send data to be displayed on the user device as a countdown clock indicating to the user the expected wait time until the message is broadcast.

3. The method of claim 2, wherein the server is to send an update to the screen or change the order of the queue to reduce the expected wait time until the message is broadcasts for a preferred user.

4. The method of claim 3 comprising changing the broadcast time slot to a pre-set broadcast time slot selected by the user.

5. The method of claim 4 comprising assigning a sooner broadcast time slot to the message by reordering the queue of messages without displacing any other pre-set broadcast time slot or sooner broadcast time slot.

6. The method of claim 1, wherein the server receives user input via a mobile app installed on the user device.

7. The method of claim 1, wherein the message is automatically filtered for prohibited content.

8. The method of claim 1, wherein the server is to send data to display on the user device an image or video feed from a camera located at the screen location to view the audience in front of the screen.

9. The method of claim 1, wherein the screens include digital billboards, electronic score boards, public televisions, public computer screens and mobile billboards.

10. A method to execute the steps of the system of claim 1.
